(19) United States
(12) Patent Application Publication
(10) Pub. No.: US 2008/0237555 A1
(43) Pub. Date: Oct. 2, 2008

(54) Scorch prevention in flexible polyurethane foams

(76) Inventors: Samuel Bron, Rehovot (IL); Ariel Sluszny, Kiryat Ata (IL); Dorit Peled, Haifa (IL); Dorit Perle, Haifa (IL); Mark Gelmont, Nesher (IL); Orly Cohen, Kiryat Ata (IL); Avi Ben-Zvi, Meitar (IL); Michael Peled, Beer-Sheeva (IL); Ron Frim, Haifa (IL)

Correspondence Address: KEVIN D. MCCARTHY;ROACH BROWN MCCARTHY & GRUBER, P.C., 424 MAIN STREET, 1920 LIBERTY BUILDING, BUFFALO, NY, 14202, US

(21) Appl. No.: 10/588,398

(22) Filed: Aug. 3, 2006

Related U.S. Application Data
(63) Continuation-in-part of application No. PCT/IL05/00554, filed on May 30, 2005.

(30) Foreign Application Priority Data
Jun. 10, 2004 (IL) 162450
May 30, 2005 (IL) PCT/IL2005/000554

(51) Int. Cl. C09K 21/12

(52) U.S. Cl. 252/609

(57) ABSTRACT

Compositions are provided for alleviating or preventing discoloration, known as “scorching”, in flame-retarded flexible polyurethane foams. The anti-scorch compositions contain combinations of antioxidant agents, epoxy compounds, organic phosphites—alone or in combination with metal salts of carboxylic acids. The compositions are useful, for example, for polyurethane foams retarded with aliphatic or aromatic phosphorus-based flame retardants, or with halogen-containing flame retardants.

### FIELD OF THE INVENTION

The present invention relates to the prevention of discoloration in flexible polyurethane foams, a phenomenon commonly referred to as “scorching”. More particularly, the invention relates to novel compositions useful to alleviate or prevent the aforementioned undesirable effect.

### BACKGROUND OF THE INVENTION

Scorching is an undesirable discoloration phenomenon which occurs within polyurethane (PU) foam blocks, causing them to assume a yellow to brown color. This discoloration is especially apparent in the center of the blocks where the internal temperatures remain high for a relatively long period of time. The exposure of the interior of the foams to high temperatures leads to embrittlement and the core discoloration commonly known as scorching. In extreme cases this can result in ignition of the foam buns, sometimes with disastrous consequences. In some severe cases, it can cause a degradation of physical properties or, where scorching is particularly intense, can result in spontaneous combustion of freshly made foam blocks.

Flame retardants (FR), with few exceptions, exacerbate the “scorch” problems that arise during processing of PU foams. Flame retardants create several problems for the manufacturers of water-blown, flexible, slab stock foams, including increased “scorch” during processing and increased smoldering tendency of foams subjected the California TB 117 standard.

Antioxidants have been proposed for use in flame retarded foams, but by themselves they are not very efficient. For example when halogen containing FR are present in the formulation. The art has so far failed to provide a generally efficient solution to the problem of scorch taking place during the manufacturing of flexible polyurethane foams comprising any FR selected from those used in the art.

It is therefore an object of the present invention to provide an anti-scorch composition addressing the problem of scorch for flame-retarded flexible polyurethane formulations.

It is another object of the present invention to provide an anti-scorch composition that efficiently addresses the problem of scorch for flexible polyurethane formulations flame retarded with scorch-inducing FR such as phosphorus-based FR or halogen-containing FR, whether aliphatic or aromatic halogenated FR, or their combination.

It is still another object of the invention to provide an anti-scorch combination that overcomes the drawbacks of the prior art.

It is yet another object of the invention to provide a method for preventing or diminishing the occurrence of scorch during the manufacturing of flexible polyurethane foams.

Other purposes and advantages of the invention will become apparent as the description proceeds.

### SUMMARY OF THE INVENTION

The invention provides an anti-scorch composition for flame-retarded flexible polyurethane foams, comprising at least one antioxidant agent, an epoxy compound, and at least one organic phosphite alone or in combination with at least one metal salt of a monocarboxylic or dicarboxylic acid. Said organic acid is selected from among saturated or unsaturated, aliphatic or aromatic, and monocarboxylic or dicarboxylic organic acids. Said metal salt is selected from the group consisting of salts of Ca, Zn, Ba, and Sn. An illustrative example of such salts may include barium oleate, barium t-butylbenzoate, barium ethylhexanoate, zinc t-butylbenzoate, calcium dimethyl ethylbenzoate, etc. Said at least one antioxidant agent, i.e. one or more compounds, may be selected from among phenols and amino oxygen scavengers, and their mixtures. Said phenol is preferably a hindered phenol, and said amino oxygen scavenger is preferably an alkylated diphenylamine. In a preferred embodiment of the invention, said at least one antioxidant agent comprises a mixture of hindered phenol and an alkylated diphenylamine. The flame-retarded foams of the invention may be retarded by any FR known in the art. In a preferred embodiment of the invention, the PU foams are retarded with phosphorus-based flame retardant (FR). In another embodiment, said flame-retarded foams are retarded with a halogen-containing flame retardant, e.g. with an aliphatic or aromatic brominated or chlorinated FR. Non-limiting examples of FR possibly used in the composition of the invention include brominated epoxy, tribromoneopentyl alcohol, tris(2-chloroisopropyl) phosphate, chlorinated alkylphosphate ester, halogenated aryl esters/aromatic phosphate blend, and pentabromobenzyl alkyl ethers. The composition with reduced scorch phenomenon according to this invention comprises an epoxy compound, which may be, for example, selected from among diglycidyl ether of bisphenol A and its derivatives. Said epoxy compound, added to the mixture of the invention, has available epoxy groups, i.e., epoxy groups essentially not neutralized by previous curing. Said organic phosphite may be, for example, selected from among tris(alkylphenyl) phosphites, trialkyl phosphites, dialkyl phenyl phosphites, alkyl diphenyl phosphites, and triphenyl phosphites.

The invention further provides a method for preventing or diminishing scorch in a flame-retarded flexible polyurethane foam, comprising adding to the polyurethane composition, prior to foaming, at least one antioxidant agent, an epoxy compound, and an organic phosphite alone or with at least one metal salt of a monocarboxylic or dicarboxylic acid. Illustrative and non-limitative examples of antioxidant agents are phenols and amino oxygen scavengers, such as hindered phenols. Illustrative and non-limitative examples of amino oxygen scavengers include alkylated diphenylamines. The flame-retardant may be a phosphorus-based flame retardant, and/or halogen-containing flame retardant, e.g. an aliphatic or aromatic brominated or chlorinated FR. According to a further preferred embodiment of the invention the composition further comprises an epoxy compound, such as—but not limited to—diglycidyl ether of bisphenol A and its derivatives.

The above and other objects and advantages of the invention will be better understood from the following illustrative and non-limitative examples.

### EXAMPLES 1-15

### Microwave (MW) Test Protocol for Scorch Evaluation

The test method consists of the following steps:

1. Foam production in a small shoe box with a square cross-section.
2. Immediately after the foam rise is complete (usually less than 2 minutes), the foam is heated using a microwave (MW) oven using a predetermined time and power level.
3. The foam is then heated in an oven at 120±2° C. for 2 min.
4. The foam is allowed to cure at RT (room temperature) for an additional 15 min.
5. By the end of the RT curing time the foam is cut (usually vertically) and the scorch is observed.

### Scorch Evaluation

The scorch is evaluated using two methods:

1. The foam is photographed using a digital camera. This allows for a visual comparison between the scorch of a reference formulation and the scorch of the formulation under investigation.
2. The foam color is analyzed using a spectrophotometer. The results are expressed in the usual color space: L*a*b and performed accordingly to ASTM D-2244.
Note: The scorch intensity may change from day to day according to the physical conditions of the surroundings in which the foam has been prepared (usually the temperature and relative humidity). This is why it is customary to prepare each day a reference sample.

### Foam Preparation

The mixture was prepared in a 0.65 l disposable cup. The components were added one at a time starting with the polyol. The mixture was vigorously mixed at 3500 rpm for 10 seconds following the addition of each component, not including the Toluene diisocyanate (TDI). After the addition of TDI, the mixture was mixed for an additional 10 sec and then poured into a 25×25×17 cm cardboard box. The times between the TDI addition and the pouring into the cardboard box and the end of the foam blowing (rise time) were monitored.

### Comparative Samples and Results

The effect of the antiscorching ingredients and their combinations was measured on the darkest areas on the foam after microwave oven treatment, using a spectrophotometer which provides color measurements expressed in the L*a*b color space. The most relevant color parameters for scorch assessment are Δb and ΔE.

The color parameters are given as normalized values relative to the reference specimens. As explained in the MW oven procedure, this particular method for scorch propensity assessment requires that a new reference foam be prepared, subjected to MW oven procedure and measured in each and every day of measurements. This requirement is related to the effect various experimental conditions, such as the temperature and the relative humidity of the air in the lab may have on the level of scorch. The normalized Δb and ΔE differences between a reference foam (containing no antiscorching ingredients) and foams containing various ingredients with antiscorch effects, are calculated as follows:

$$ΔΔ b ( normalized ) = \frac{Δ b ( reference ) - Δ b ( sample )}{Δ b ( reference )} \cdot 100$$

$$ΔΔ E ( normalized ) = \frac{Δ E ( reference ) - Δ E ( sample )}{Δ E ( reference )} \cdot 100$$

Note: A value greater than 100 can sometimes emerge from these calculations since both Δb and ΔE for each specimen are compared to a factory white standard. The higher the ΔΔb and ΔΔE values, the lower the scorch.

Formulations for two grades of foams are shown in Tables I and II: Medium density foams (Table I) have a density of approximately 25 Kg/m³; Low density foams (Table II) have a density of approximately 15 Kg/m³. The component amounts in tables I, II, IV, and V are expressed as weight parts relative to 100 parts of polyol (phr).

Ingredients: AO1 and AO5 are antioxidants produced by Goldschmidt (Degussa) and contain combinations of hindered phenols and aromatic diamines.

Epoxy 828 is Diglycidyl ether of bisphenol A (DGEBA).

ESBO=Epoxidized Soya Bean oil.

All other ingredients below the FR-13 line in the table are metallic salts (Ca, Zn, Ba, Sn) of organic acids, and organic phosphites.

TABLE I
Anti-scorch performance of medium density foams

| | 1 | 2 | 3 | 4 | 5 | 6 | 7 | 8 | 9 |
|---|---|---|---|---|---|---|---|---|---|
| Polyol | 100 | 100 | 100 | 100 | 100 | 100 | 100 | 100 | 100 |
| Water | 4.2 | 4.2 | 4.2 | 4.2 | 4.2 | 4.2 | 4.2 | 4.2 | 4.2 |
| Silicon 8228 | 1.1 | 1.1 | 1.1 | 1.1 | 1.1 | 1.1 | 1.1 | 1.1 | 1.1 |
| Amine Dabco 33LV | 0.09 | 0.09 | 0.09 | 0.09 | 0.09 | 0.09 | 0.09 | 0.09 | 0.09 |
| Amine BDE | 0.03 | 0.03 | 0.03 | 0.03 | 0.03 | 0.03 | 0.03 | 0.03 | 0.03 |
| Tin T-9 | 0.25 | 0.25 | 0.25 | 0.25 | 0.25 | 0.25 | 0.25 | 0.25 | 0.25 |
| Toluene di-isocyanate | 56.31 | 56.31 | 56.31 | 56.31 | 56.31 | 56.31 | 56.31 | 56.31 | 56.31 |
| (TDI) | | | | | | | | | |
| FR-513 | 5 | 5 | 5 | 5 | 5 | 5 | 5 | 5 | 5 |
| AO5 | 0.42 | 0.21 | 0.85 | | | | | | |
| Calcium stearate (CaSt) | 0.42 | 0.21 | | | | | | | |
| PK4610 | 0.42 | 0.21 | | | | | | | |
| Epoxy 828 | | | 0.85 | | 0.1 | 0.1 | 0.21 | | |
| ESBO | | | | 1.7 | | | | | |
| LZB 138 | | | | | 0.21 | | | 0.21 | 0.21 |
| AO 1 | | | | | 0.21 | 0.21 | 0.21 | 0.21 | 0.21 |
| CZ400 | | | | | | 0.21 | | 0.21 | |
| CZ 118 S | | | | | | | 0.21 | | 0.21 |
| ΔΔb | 90.13 | 106.1 | 49.17 | −132.6 | 82.32 | 77.06 | 93.93 | 84.58 | 102.9 |
| ΔΔE | 17.04 | 10.84 | 18.34 | −99.43 | 27.61 | 32.67 | 30.14 | 37.42 | 33.98 |

TABLE II
Anti-scorch performance of low density foams

| | 10 | 11 | 12 | 13 | 14 | 15 |
|---|---|---|---|---|---|---|
| Polyol | 100 | 100 | 100 | 100 | 100 | 100 |
| Water | 5.25 | 5.25 | 5.25 | 5.25 | 5.25 | 5.25 |
| Silicon 8228 | 1.0 | 1.0 | 1.0 | 1.0 | 1.0 | 1.0 |
| Amine Dabco | 0.06 | 0.06 | 0.06 | 0.06 | 0.06 | 0.06 |
| 33LV | | | | | | |
| Amine BDE | 0.046 | 0.046 | 0.046 | 0.046 | 0.046 | 0.046 |
| Tin T-9 | 0.37 | 0.37 | 0.37 | 0.37 | 0.37 | 0.37 |
| Methylene | 11 | 11 | 11 | 11 | 11 | 11 |
| Chloride | | | | | | |
| (MeCl) | | | | | | |
| TDI | 71.1 | 71.1 | 71.1 | 71.1 | 71.1 | 71.1 |
| FR-513 | 15 | 15 | 15 | 15 | 15 | 15 |
| AO5 | | | 0.1 | 0.3 | | 0.2 |
| Epoxy 828 | 0.5 | 1.0 | | | | |
| BM270 | | | | | 1.0 | 0.2 |
| LZB287 | | | | | | 0.6 |
| ΔΔb | −14.11 | 24.37 | −15.10 | −77.1 | 95.29 | 50.90 |
| ΔΔE | 0 | 13.73 | −10.13 | −41.03 | 27.80 | 11.70 |

TABLE III
Composition of ingredients used as antiscorch materials.

| Producer | Name | Ingredients | | State |
|---|---|---|---|---|
| Akcros | Lankromark LZB287 | 1) Barium oleate | 40% | Liquid |
| | | Barium t-butylbenzoate | | |
| | | 2) Zink 2-ethylhexanoate | 5-10% | |
| | | 3) Phosphite esters | 20-40% | |
| | | 4) 2-(2-butoxyethoxy)ethanol | 5-10% | |
| | | 5) Phenol | 5-10% | |
| | Lankromark LZB413 | 1) Barium 2-ethylhexanoate | 20% | Liquid |
| | | Barium oleate | | |
| | | Barium t-butylbenzoate | | |
| | | 2) Zinc 2-ethylhexanoate | 1-5% | |
| | | 3) Zinc t-butylbenzanoate | 1-5% | |
| | | 4) Phosphite esters | 20-40% | |
| | | 5) Tris(nonylphenyl) phosphite | 1-5% | |
| | | 6) 2-(2-butoxyethoxy ethanol) | | |
| | Lankromark LZB138 | 1) Barium oleate | ~30% | Liquid |
| | | Barium t-butylbenzoate | | |
| | | 2) Zinc 2-ethylhexanoate | 10-20% | |
| | | 3) Phosphite esters | 20-40% | |
| | | 4) 2-(2-butoxyethoxy) ethanol | 5-10% | |
| | | 5) Phenol | 1-5% | |
| | Lankroflex E2307 | 1) Epoxidized soya bean oil | >99% | Liquid |
| | Tinstab BTS71S | 1) n-Butyltin tris (2-ethylhexylthio-glycolate) | ~20% | Liquid |
| | | 2) Di-n-butyltin bis (2-ethylhexylthio-glycolate) | ~70% | |
| | Tinstab BM270 | 1) Di-n-butyltin bis (methylmaleate) | ~95% | Liquid |
| Shell | Epoxy 828 | | ~100% | Liquid |
| Chemson | Naftosafe PK4610 | Ca/Zn organic stabilizer | — | Powder |
| Group | | | | |
| Gold- | Ortegol AO1 | Steric hindered phenol derivate | 66.7% | |
| schmidt | | Alkylated diphenylamine | 33.3% | |
| | Ortegol AO5 | Steric hindered phenol derivate | 70-72% | |
| | | Alkylated diphenylamine | 20-22% | |
| Crompton | Mark CZ 400 (Ca/Zn | 2-(2-Butoxyethoxy)ethanol | <10% | Liquid |
| | stabilizer) | Alkylarylphosphites | 55-65% | |
| | | Calcium 4-(1,1-dimethylethyl)benzoate | <10% | |
| | | Tris(nonylphenyl)phosphite | 30-40% | |
| | Mark CZ 118S | Other components —not listed | | Liquid |
| | (Ca/Zn stabilizer) | | | |
| | Mark BZ 592 (Ba/Zn | Solvent naphta, light aromatic | <10% | Liquid |
| | stabilizer) | Barium compounds | 35-45% | |
| | | Triisodecyl phosphite | <25% | |
| | Mark BZ 562 | Solvent naphta, light aromatic | <10% | Liquid |
| | (Ba/Zn stabilizer) | Alkylarylphosphites | 20-30% | |
| | | Zinc bis(p-nonylphenolate) | <3% | |
| | | Barium compounds | 35-45% | |
| | Mark BZ 555 | Tris(2-ethylhexylmercaptoacetate) phosphate | 5-15% | Liquid |
| | (Ba/Zn stabilizer) | Diisodecyl phenyl phosphite | 25-35% | |
| | | Solvent naphta, light aromatic | 5-15% | |
| | | Barium compounds | 20-30% | |
| | Mark BZ 563 | Diisodecyl phenyl phosphite | 30-50% | Liquid |
| | (Ba/Zn stabilizer) | 2-(2-Butoxyethoxy)ethanol | <5% | |
| | | Zinc bis(p-nonylphenolate) | <5% | |
| | | Barium compounds | 20-30% | |

From the results in Tables I and II it is clearly seen that the compositions of the invention attain a substantial improvement.

The notations and composition of materials used as antiscorch ingredients in the examples in Tables I and II are detailed in Table III.

Example 3 in Table I and Examples 12 and 13 in Table II, respectively, demonstrate that the use of a conventional antioxidant, i.e. a mixture of hindered phenols and alkylated diphenyldiamines, alone or together with an epoxy moiety, does not prevent scorch in a bromine-containing FR formulation. Epoxy alone, either as DGEBA or ESBO, are not effective either (Examples 4 in Table 1, and Examples 10 and 11 in Table II). However, addition of organic phosphites alone or in combination with metallic salts of various organic acids, significantly improves the resistance to scorch of a polyurethane flexible foam formulation including a bromine-containing flame retardant (Examples 8, 9—Table I, and Examples 14, 15—Table II).

### EXAMPLES 16-25

### MW test Protocol for Scorch Evaluation

1. Foam production in a small shoe box with a square cross-section.
2. Immediately after the foam rise is complete (usually less than 2 minutes), the foam is heated in a microwave (MW) oven that is equipped with an electronic controlling circuit that controls the overall heating energy emitted by the MW oven. Controlling feedback is accomplished via measuring the temperature of a given constant mass of water co-heated alongside the foam. The water temperature closely follows a pre-set rate of temperature rise (ramp) over a predetermined period of time so that a constant temperature difference is maintained in each heating cycle.
3. The foam is then placed in an oven at 110-120° C. for 17 minutes not only to cure but also to slow down the foam's natural cooling and to isolate it from climate and surrounding changes as well. The foam's core temperature is being monitored throughout this stage with a k-type 1.6 mm diameter thermocouple plugged into a data-logger.
4. Following the 17 minutes curing the foam is sliced perpendicular to foam rise direction, obtaining square cross-section slices. The surface of the central slice is then photographed and its scorch level is evaluated.

### Digital Scorch Evaluation

The effect of anti-scorching ingredients on various scorch-forming halogenated flame retardants in various common flexible polyurethane formulations was measured all over the surface of the central foam slice, where the foam core temperature was the highest along the disclosed procedure, rather than locally on selected darkest zones alone. Digital photographs taken under fully controlled parameters (illumination, filming angles) were processed by graphic software that scans the photographs having the same resolution and sums up the number of pixels having different colors over a selected slice area. The resulting value, Unique Colors (UC), highly correlates with the visual comparative inspection of scorch intensity. The UC values are straightforward, the lower they are the less scorched is the foam. A reduced UC value indicates a better anti-scorch effect.

Note: the controlled emission of the MW energy during the foam heating stage of the test procedure, together with the controlled and slowed down cooling of the foam that is isolated from the surrounding climate changes, were statistically proved to accomplish highly reproducible day-to-day results. Scanning to measure the entire scorched area also was well contributing to the accuracy and reproducibility of the test procedure. Nevertheless, often a reference formulation was carried as an internal test to assure that test parameters are fully kept and the resulting scorch intensity falls within the narrow variability limits of the procedure.

### Foam Preparation

The foam mixture was prepared in a 0.65 l disposable cup. All components, but the water and the toluene di-isocyanate (TDI), were successively added starting with the polyol. The mixture was vigorously mixed at 4400 rpm for 15 seconds, followed by the injection of pre-weighed water under continuous mixing. Mixing was allowed for 20 seconds more before the pre-weighed TDI was introduced, followed by 10 seconds of further mixing and an immediate pouring of the mixture into a 25×25×17 cm³ cardboard box. Foam rise time, from pouring to blow-off was recorded.

Various halogen-containing common commercial flame retardants, among them some well known to be accompanied by an intense scorching process, were introduced into the foam formulations. The marked effect of the combination of the anti-scorching components was demonstrated by comparing the measured scorch intensity (UC values) with and without the presence of each of these flame retardants in the formulation. These results and the normal density formulation (foam density ca. 25 Kg/m³ in FR-513 containing foams) used with the various flame retardants—with the necessary changes of TDI—is presented in table IV. The efficacy of the same combination of anti-scorching components toward various halogen-containing flame retardants is shown to be equally high for different foam formulations or foam densities, as presented in table V.

A combination of anti-scorch ingredients according to the invention, comprising hindered phenol, alkylated diphenylamine, epoxy compound, and organic phosphites with or without metallic salts of organic acids, is demonstrated hereafter to effectively diminish or prevent the scorch occurrence within foams containing scorch-forming flame retardants, such as: halogenated—wherein the halogen is either aromatic or aliphatic—and/or halogenated phosphates—wherein the halogen is either aromatic or aliphatic- and/or phosphorus-based flame retardants. Illustrative and non-limitative examples of such flame retardants are: tribromoneopentyl alcohol (FR-513 ex Dead Sea Bromine Group, DSBG), tris(2-chloroisopropyl) phosphate (TCPP, Fyrol FR-2 ex Akzo Nobel), chlorinated alkylphosphate ester (Amgard V6 ex Albright and Wilson/Antiblaze V6 ex Albemarle), Halogenated aryl esters/Aromatic phosphate Blend (FM-550 ex Great Lakes), pentabromobenzyl alkyl ethers (FR-1435X ex DSBG), brominated epoxy F-3014 (ex DSBG) dissolved in phosphates (Phosflex 31 L ex Akzo Nobel) 1:1 w/w.

The selected combination of the anti-scorch ingredients comprises the materials:

AO5: Antioxidant produced by Goldschmidt (Degussa), containing a combination of hindered phenols and aromatic diamines.

Epoxy 828: EPON™ Resin 828 produced by Resolution Performance Products is Diglycidyl ether of bisphenol A (DGEBA).

Metallic (Ba, Zn, Ca or Sn) salts of organic acids and organic phosphites are included in Baerlocher™ product.

TABLE IV
Anti-scorch performance of medium density foams with
halogenated or phospho-halogenated flame retardants

| Ingredient | 16 | 16a | 17 | 17a | 18 | 18a | 19 | 19a | 19b | 20 | 20a | 21 | 21a |
|---|---|---|---|---|---|---|---|---|---|---|---|---|---|
| Flame | Fyrol FR-2 | | Amgard V6 | | F-3014 & | | FR-513 | | | FM 550 | | FR-1435X | |
| retardant | (TCPP) | | | | (Antiblaze | | | | | Phosphates | | | |
| | | | | | V6) | | | | | | | | |
| | 15 | | 10 | | 13 | | 8 | | | 14 | | 14 | |
| Polyol | 100 | | 100 | | 100 | | 100 | | | 100 | | 100 | |
| Silicon Niax | 0.95 | | 0.95 | | 0.95 | | 0.95 | | | 0.95 | | 0.95 | |
| L-650 | | | | | | | | | | | | | |
| Amine Dabco | 0.018 | | 0.018 | | 0.018 | | 0.018 | | | 0.018 | | 0.018 | |
| 33LV | | | | | | | | | | | | | |
| Amine BDE | 0.0624 | | 0.0624 | | 0.0624 | | 0.0624 | | | 0.0624 | | 0.0624 | |
| Tin T-9 | 0.153 | | 0.153 | | 0.153 | | 0.153 | | | 0.153 | | 0.153 | |
| Water | 4.63 | | 4.63 | | 4.63 | | 4.63 | | | 4.63 | | 4.63 | |
| Toluene di- | 62.03 | | 62.03 | | 62.53 | | 64.59 | | | 62.03 | | 62.03 | |
| isocyanate | | | | | | | | | | | | | |
| (Index 119) | | | | | | | | | | | | | |
| Anti-scorch | 0.0 | 1.0 | 0.0 | 1.0 | 0.0 | 1.0 | 0.0 | 1.0 | — | 0.0 | 1.0 | 0.0 | 1.0 |
| Combinat. 1^{a} | | | | | | | | | | | | | |
| Anti-scorch | | | | | | | | | 1.0 | | | | |
| Combinat. 2^{b} | | | | | | | | | | | | | |
| Scorch level | 23408 | 4927 | 43188 | 7777 | 28238 | 6134 | 27414 | 5640 | 5238 | 7111 | 5950 | 7806 | 5956 |
| (UC) | | | | | | | | | | | | | |
| Scorch | | −79 | | −82 | | −78 | | −79 | −81 | | −16 | | −24 |
| reduction, % | | | | | | | | | | | | | |

^{a}A combination of anti-scorch components that contains an anti-oxidant, epoxy, organic phosphites and metal salts of organic acids.
^{b}A combination of anti-scorch components that contains an anti-oxidant, epoxy and organic phosphites.

The anti-scorch combination (AS package) demonstrated in Table IV is shown to maintain its high efficacy in diminishing or preventing scorching in foams containing scorch-forming flame retardants independently of the foam formulation, or the foam densities (e.g. normal—ca. 25 kg/m³ or low—ca. 15 kg/m³, in FR-513 containing foams). These results are presented in table V.

TABLE V
Anti-scorch performance of medium and low density
formulations with different FRs

| | 22 | 22a | 23 | 23a | 24 | 24a | 25 | 25a |
|---|---|---|---|---|---|---|---|---|
| | Normal density foams - | | | | Low density | | | |
| Ingredient | Second formulation | | | | foams | | | |
| Flame | Fyrol FR-2 | | FR-513 | | Fyrol FR-2 | | FR-513 | |
| retardant | (TCPP) | | | | (TCPP) | | | |
| | 15 | | 6.5 | | 15 | | 8 | |
| Polyol | 100 | | 100 | | 100 | | 100 | |
| Silicon Niax | 1.1 | | 1.1 | | 1.0 | | 1.0 | |
| L-650 | | | | | | | | |
| Amine Dabco | 0.09 | | 0.09 | | 0.06 | | 0.06 | |
| 33LV | | | | | | | | |
| Amine BDE | 0.03 | | 0.03 | | 0.047 | | 0.047 | |
| Tin T-9 | 0.25 | | 0.25 | | 0.37 | | 0.37 | |
| MeCl₂ | — | | — | | 11.0 | | 11.0 | |
| Water | 4.20 | | 4.20 | | 5.25 | | 5.25 | |
| Toluene di- | 54.68 | | 56.67 | | 66.27 | | 68.72 | |
| isocyanate | | | | | | | | |
| (Index 114) | | | | | | | | |
| Anti-scorch | 0.0 | 1.0 | 0.0 | 0.81 | 0.0 | 1.0 | 0.0 | 1.0 |
| Combinat. 1^{a} | | | | | | | | |
| Scorch level | 24537 | 4758 | 23667 | 5706 | 8159 | 5421 | 7910 | 4700 |
| (UC) | | | | | | | | |
| Scorch | | −81 | | −76 | | −34 | | −41 |
| reduction, % | | | | | | | | |

^{a}A combination of anti-scorch components that contains an anti-oxidant, epoxy, organic phosphites and metal salts of organic acids.

Considering the background color measured over non-scorched areas, the selected anti-scorch package has been proved to significantly reduce and nearly to diminish scorch occurrence in flexible polyurethane foams containing scorch-forming flame retardants, independently of their formulation or density.

A clear improvement was also achieved in foams containing flame retardant that so far were considered by foam producers to produce an acceptable scorch level, such as the case of FM 550.

All the above description has been provided for the purpose of illustration, and is not intended to limit the invention in any way. Various modifications can be carried out in the method and system according to the invention, without departing from its spirit.

1. An anti-scorch composition for flame-retarded flexible polyurethane foams, comprising at least one antioxidant agent, an epoxy compound, and at least one organic phosphite alone or in combination with at least one metal salt of a monocarboxylic or dicarboxylic acid.

2. A composition according to claim 1, wherein said organic acid is selected from among saturated or unsaturated, aliphatic or aromatic, and monocarboxylic or dicarboxylic organic acids.

3. A composition according to claim 1, wherein the metal in said metal salt is selected from the group consisting of Ca, Zn, Ba, and Sn.

4. A composition according to claim 1, wherein said at least one antioxidant agent is selected from among phenols and amino oxygen scavengers.

5. A composition according to claim 4, wherein the phenol is a hindered phenol.

6. A composition according to claim 4, wherein the amino oxygen scavenger is an alkylated diphenylamine.

7. A composition according to claim 1, wherein said at least one antioxidant agent comprises a mixture of hindered phenol and an alkylated diphenylamine.

8. A composition according to claim 1, wherein said flame-retarded foams are retarded with an aliphatic or aromatic, phosphorus-based, flame retardant (FR).

9. A composition according to claim 1, wherein said flame-retarded foams are retarded with a halogen-containing flame retardant.

10. A composition according to claim 1 wherein said flame-retarded foams are retarded with an aliphatic or aromatic, brominated or chlorinated, FR.

11. A composition according to claim 1, wherein said flame-retarded foams are retarded with a FR selected from the group consisting of tribromoneopentyl alcohol, tris(2-chloroisopropyl) phosphate, tris(dichloropropyl) phosphate, chlorinated alkyl phosphate ester, halogenated aryl esters/aromatic phosphate blend, pentabromobenzyl alkyl ethers, and brominated epoxy.

12. A composition according to claim 1, wherein said epoxy compound is selected from among diglycidyl ether of bisphenol A and its derivatives.

13. A composition according to claim 1, wherein said organic phosphite is selected from among tris(alkylphenyl) phosphites, trialkyl phosphites, dialkyl phenyl phosphites, triphenyl phosphites, and alkyl diphenyl phosphites.

14. A method for preventing or diminishing scorch in a flame-retarded flexible polyurethane foam, comprising adding to the polyurethane composition, prior to foaming, at least one antioxidant agent, an epoxy compound, and organic phosphites alone or in combination with at least one metal salt of a monocarboxylic or dicarboxylic acid.

15. A method according to claim 14, wherein the organic acid is selected from among saturated or unsaturated, aliphatic or aromatic, monocarboxylic or dicarboxylic organic acids.

16. A method according to claim 14, wherein the metal in said metal salt is selected from the group consisting of Ca, Zn, Ba or Sn.

17. A method according to claim 14, wherein said at least one antioxidant agent is selected from among phenols and amino oxygen scavengers.

18. A method according to claim wherein 14, wherein said phenol is a hindered phenol.

19. A method according to claim 14, wherein said amino oxygen scavenger is an alkylated diphenylamine.

20. A method according to claim 14, wherein said at least one antioxidant agent comprises a mixture of hindered phenol and an alkylated diphenylamine.

21. A method according to claim 14, wherein said flame-retarded foam is retarded with an aliphatic or aromatic, phosphorus-based, flame retardant FR).

22. A method according to claim 14, wherein said flame-retarded foam is retarded with a halogen-containing flame retardant.

23. A method according to claim 14, wherein said flame-retarded foam is retarded with a brominated or chlorinated, aliphatic or aromatic, FR.

24. A method according to claim 14, wherein said flame-retarded foam is retarded with a FR selected from the group consisting of tribromoneopentyl alcohol, tris(2-chloroisopropyl) phosphate, tris(dichloropropyl) phosphate, chlorinated alkylphosphate ester, halogenated aryl esters/aromatic phosphate blend, pentabromobenzyl alkyl ethers, and brominated epoxy.

25. A method according to claim 14, wherein said epoxy compound is selected from among diglycidyl ether of bisphenol A and its derivatives.

26. A method according to claim 14, wherein said organic phosphite is selected from among tris(alkylphenyl) phosphites, trialkyl phosphites, dialkyl phenyl phosphates, triphenyl phosphites, and alkyl diphenyl phosphites.
